(19) United States
(12) Patent Application Publication
(10) Pub. No.: US 2003/0066047 A1
(43) Pub. Date: Apr. 3, 2003

(54) General-purpose software development support system

(75) Inventor: Shinichiro Watase, Kanagawa-Ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/235,784

(22) Filed: Sep. 6, 2002

(30) Foreign Application Priority Data
Sep. 28, 2001 (JP) 2001-300116

(51) Int. Cl. G06F 9/44

(52) U.S. Cl. 717/100

(57) ABSTRACT

The general-purpose software development support system 1 includes a drawing tool part 10 that provides a user with a user interface for defining the flow of processes among a plurality of software components as a connection relationship of the icons on the tool screen 41. The system 1 also includes a definition file storing part 37 that stores a framework definition file 30 including definition files 31, 32, 33 and 34; and a customizing part 20 that customizes the user interface provided by the drawing tool part 10, on the basis of the definition files 31, 32, 33 and 34 stored in said definition file storing part 37. The definition files 31, 32, 33 and 34 includes definition information and design information with respect to each of the software components, which specify a setting and an operation of the user interface provided by the drawing tool part 10.

### BACKGROUND OF THE INVENTION

1. Field of the Invention

The present invention relates to a system for supporting a development of a software product, and more particularly to a general-purpose software development support system capable of flexibly customizing a software development environment.

2. Description of the Related Art

Conventionally, as such a kind of software development support system, known is a CASE (computer aided software engineering) tool, which provides a user with a user interface for defining the flow of processes among a plurality of software components as a connection relationship of icons on a tool screen.

Generally, in such a CASE tool, software components executing a part of processes of the software product to be developed are displayed on the tool screen as icons; and the structure of the software product (the flow of processes among the software components) can be defined by connecting such icons with lines.

As mentioned above, in the conventional CASE tool, the structure of the software product can be defined as graphic representation of a connection relationship of the icons; thus, the work for,developing the software product can be carried out such that a human can easily recognize it, and the developed software can be comparatively easily managed.

However, in developing aforementioned conventional CASE tool, it is necessary to prepare an execution code of each software component and also to describe as codes definition information and design information of each of the software components, which are necessary for the user interface of the CASE tool. It is noted that the definition information includes basic information such as attributes of software components and input-output relations; and the design information includes information such as a procedure of displaying setting dialogs for setting of operations of software components, icon images of software components, etc.

Therefore, in the aforementioned conventional CASE tool, when a software component or a framework (a set of software components) is added, not only an execution code but also a code for integrating it in the CASE tool must be prepared for each software component; thus, new software components and frameworks cannot be easily added into the CASE tool.

In addition, a code for integrating a new software component or a framework in a CASE tool is closely related with a language for implementation and an internal structure (architecture) of a specific CASE tool. Therefore, when the language for implementation and an internal structure of the CASE tool are changed; such a code for integrating anew software component or a framework in a CASE tool must be newly prepared; thus, the existing software components cannot be easily reused.

### SUMMARY OF THE INVENTION

The present invention has been made in view of the foregoing circumstances; and it is therefore an object of the present invention to provide a general-purpose software development support system, which can easily add, reuse and maintain software components, a method and a program product for carrying out the same, and a software component adapted to be used with the general-purpose software development support system.

A first aspect of the present invention is a general-purpose software development support system for supporting a development of a software product consisting of a plurality of software components. The system comprises: a drawing tool part that provides a user with a user interface for defining a flow of processes among a plurality of software components by connecting icons of the software components by lines on a tool screen; a definition file storing part that stores a definition file including definition information and design information with respect to each of the software components, the definition information and the design information specifying a setting and an operation of the user interface provided by the drawing tool part; and a customizing part that customizes the user interface provided by the drawing tool part, on the basis of the definition file stored in the definition file storing part.

In the aforementioned first aspect, the customizing part preferably includes an interpretation executing part that interprets the definition file stored in the definition file storing part to set an operation of the user interface on the basis of the definition information and the design information of each of the software components included in the definition file. In addition, the customizing part preferably includes an interface operation control part that controls an operation of the user interface on the basis of interpretation results obtained by the interpretation executing part.

A second aspect of the present invention is a general-purpose software development support method for supporting a development of a software product consisting of a plurality of software components, providing a user with a user interface for defining a flow of processes among the software components by connecting icons of the software components by lines on a tool screen. The method comprises the steps of: preparing a definition file including definition information and design information with respect to each of the software components, the definition information and the design information specifying a setting and an operation of the user interface; and setting an operation of the user interface on the basis of the definition information and the design information of each of the software components included in the definition file.

In the aforementioned second aspect, the method preferably comprises the step of controlling an operation of the user interface, while interpreting the definition information and the design information of each of the software components included in the definition file.

A third aspect of the present invention is a general-purpose software development support program product for supporting a development of a software product consisting of a plurality of software components, providing a user with a user interface for defining a flow of processes among the software components by connecting icons of the software components by lines on a tool screen. The program product makes a computer execute the procedures of: preparing a definition file including definition information and design information with respect to each of the software components, the definition information and the design information specifying a setting and an operation of the user interface; and setting an operation of the user interface on the basis of the definition information and the design information of each of the software components included in the definition file.

In the aforementioned third aspect, the program product preferably makes a computer execute the procedure of controlling an operation of the user interface, while interpreting the definition information and the design information of each of the software components included in the definition file

A fourth aspect of the present invention is a software component adapted to be used with a general-purpose software support system that interprets a definition file to customize a user interface. The software component comprises: an execution code for executing a process of the software component on a computer; and a definition file accompanying the execution code, the definition file including definition information and design information inherent to the software component, the definition information and the design information specifying a setting and an operation of the user interface.

In the aforementioned first to fourth aspects, the definition file is preferably described in a versatile specification description language.

According to the present invention, the definition information and the design information, which are set as information inherent to the software components and necessary for setting the user interface of the drawing tool part, are prepared as a definition file, independently of the drawing tool part; and during operation of the drawing tool part, the system reads the definition file and operates. Therefore, unless the program of the drawing tool part is changed and extended, new software components and frameworks (sets of software components) can be easily added.

Further, according to the present invention, the definition file is described in a versatile specification description language independent of a specific language for implementation. Therefore, in the case that a function for interpreting the specification description language is provided, even if a language for implementation or an internal structure of the drawing tool part is changed, the existing software components can be reused as they are.

### BRIEF DESCRIPTION OF THE DRAWINGS

In the drawings,

FIG. 1 is a functional block diagram showing an embodiment of the general-purpose software development support system of the present invention;

FIG. 2 shows an example of a user interface (tool screen) used in the general-purpose software development support system shown in FIG. 1;

FIG. 3 shows an example of a framework information definition file included in the framework description file shown in FIG. 1;

FIG. 4 shows an example of a component basic information definition file included in the framework description file shown in FIG. 1;

FIG. 5 shows an example of a setting dialog definition file included in the framework description file shown in FIG. 1;

FIG. 6 shows an image of a setting dialog displayed on the tool screen on the basis of the setting dialog definition file shown in FIG. 5;

FIG. 7 shows an icon image displayed on the tool screen on the basis of an icon image definition file included in the framework description file shown in FIG. 1; and

FIG. 8 is a hardware block diagram showing an example of a computer system, to which the general-purpose software development support system shown in FIG. 1 is applied.

### DESCRIPTION OF THE PREFERRED EMBODIMENTS

The embodiments of the present invention will be explained hereafter with reference to the accompanying drawings.

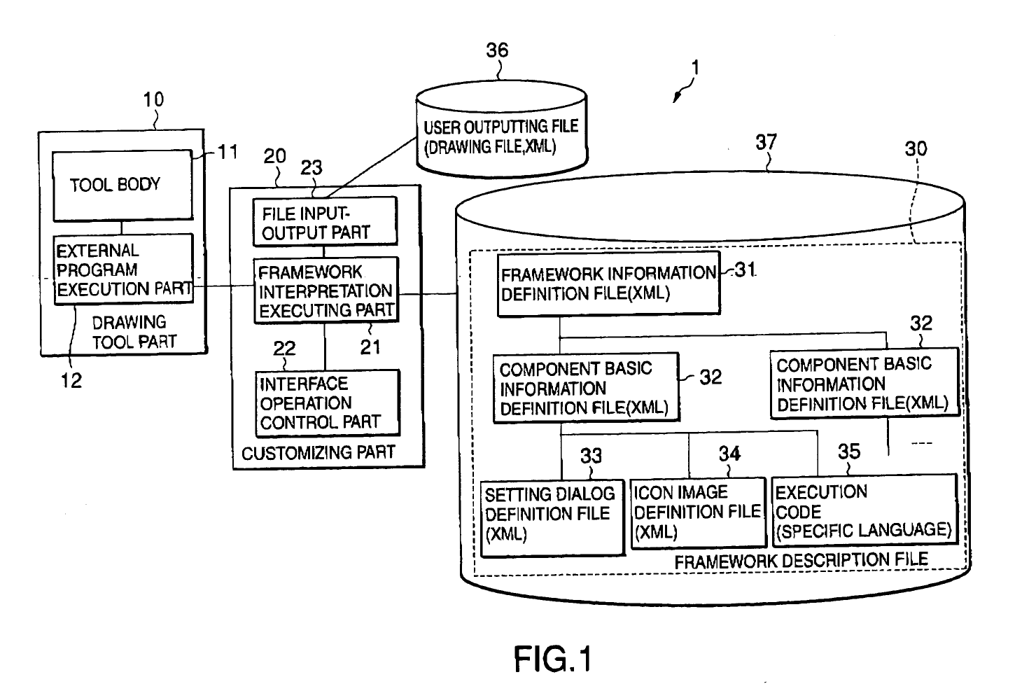

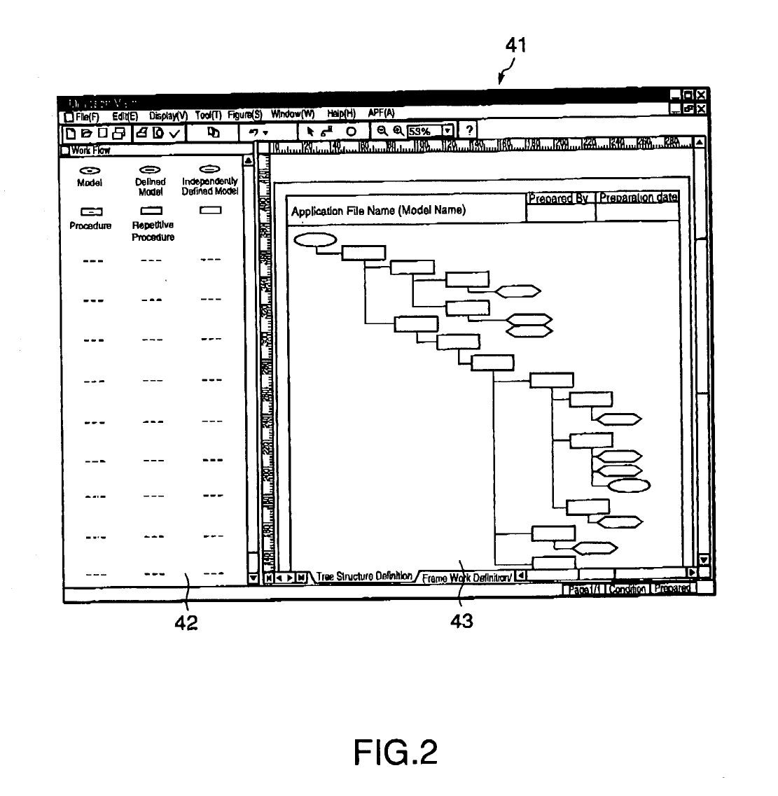

FIG. 1 shows an embodiment of the general-purpose software development support system of the present invention. As shown in FIG. 1, a general-purpose software development support system 1 according to this embodiment includes a drawing tool part 10 that provides a user with a user interface for defining the flow of processes among a plurality of software components as a connection relationship of the icons on the tool screen 41 (see FIG. 2). The general-purpose software development support system 1 also includes a definition file storing part 37 that stores a framework definition file 30 including definition files (a framework information definition file 31, a component basic information definition file 32, a setting dialog definition file 33, and an icon image definition file 34 included in a framework description file 30). The general-purpose software development support system 1 also includes a customizing part 20 that customizes the user interface provided by the drawing tool part 10, on the basis of the definition files 31, 32, 33 and 34 stored in said definition file storing part 37. The definition files 31, 32, 33 and 34 includes definition information and design information with respect to each of the software components, which specify a setting and an operation of the user interface provided by the drawing tool part 10.

Specifically, the drawing tool part 10 has a tool body 11 and an external program execution part 12 for calling an external program (the customizing part 20) under control of the tool body 11.

In this case, the tool body 11 is realized by an existing versatile drawing tool program independent of a specific domain (work field) and a specific software component; and the flow of processes among the software components can be defined as a connection relationship of the icons on the tool screen 41 shown in FIG. 2, under instructions from a user, which are given by operations of a mouse or a keyboard.

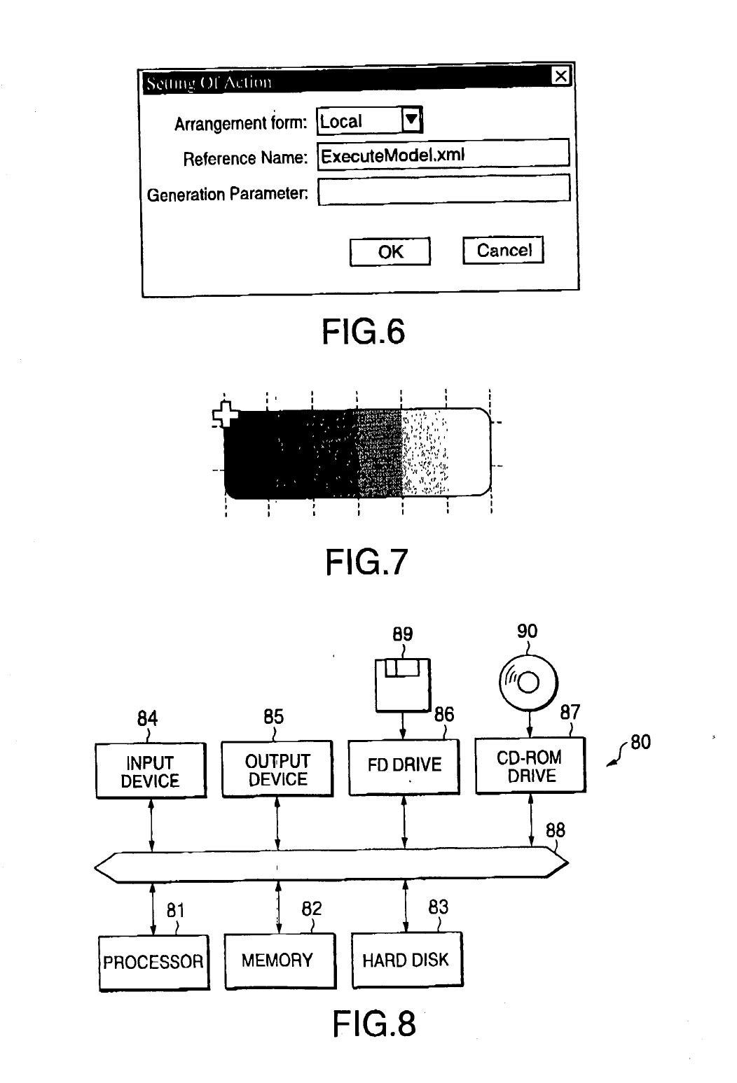

Specifically, on the tool screen 41 shown in FIG. 2, a desired icon is selected from the icons arranged on a pallet 42; and a predetermined operation (a drag-and-drop operation, etc.) is performed for the icon so that the icon can be arranged in an edit area 43. Further, by connecting the icons with a line in the edit area 43, a plurality of software components can be connected. Furthermore, by popping up a setting dialog for the icons arranged in the edit area 43, the operation of the software components can be set through the popped-up setting dialog (see FIG. 6).

The customizing part 20 has a framework interpretation executing part 21, an interface operation control part 22 and a file input-output part 23. In this embodiment, the customizing part 20 is implemented as an add-on program to the drawing tool part 10.

In this customizing part 20, the framework interpretation executing part 21 is a kind of interpreter for interpreting the definition files (the framework information definition file 31, the component basic information definition file 32, and the setting dialog definition file 33) included in the framework description file 30 under control of the drawing tool part 10; and the framework interpretation executing part 21 can set the operation of the user interface on the basis of the definition information and design information of each software component, which are described in the definition files 31, 32 and 33. The interface operation control part 22 controls the operation of the user interface (display of the setting dialog, etc.) on the basis of the interpretation results obtained by the framework interpretation executing part 21.

In this case, the framework description file 30 defines a development environment (framework) for constructing specific software and includes the definition information and the design information of each software component, which are necessary for the user interface provided by the drawing tool part 10. The definition information includes basic information such as attributes of software components and input-output relations; and the design information includes information such as a, procedure of displaying setting dialogs for setting of operations of software components, icon images of software components, etc.

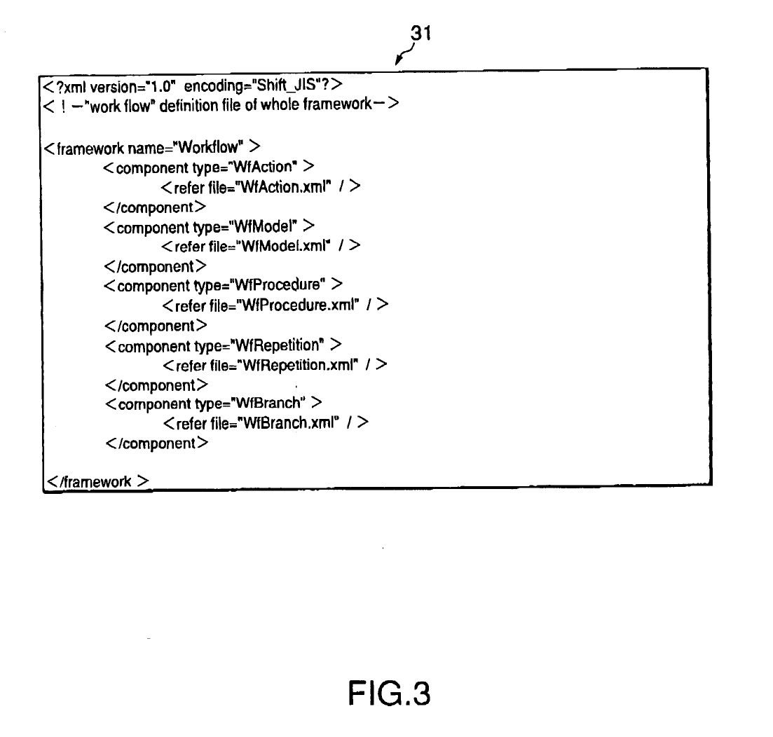

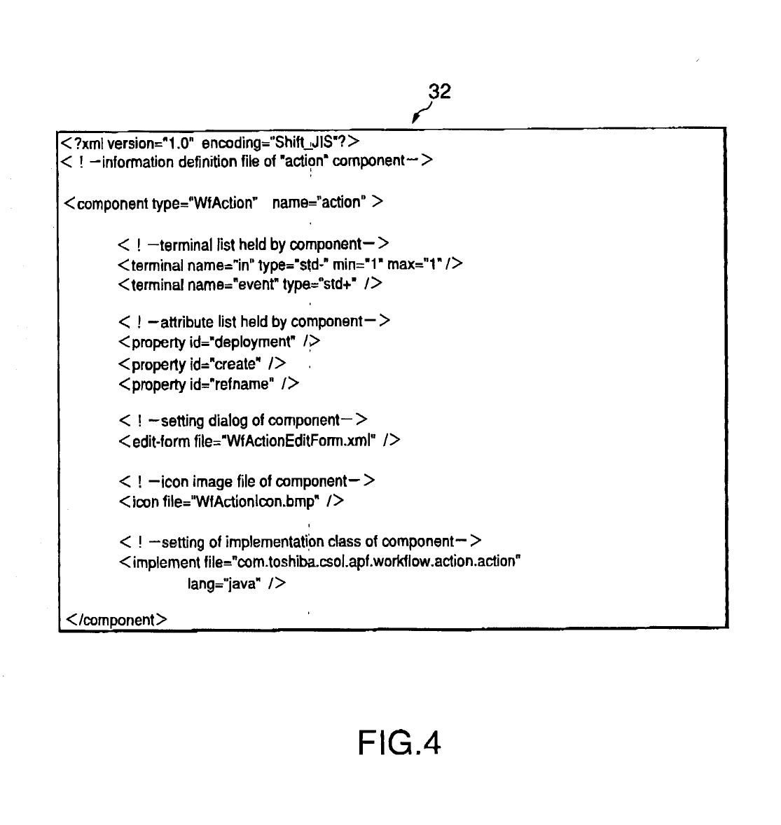

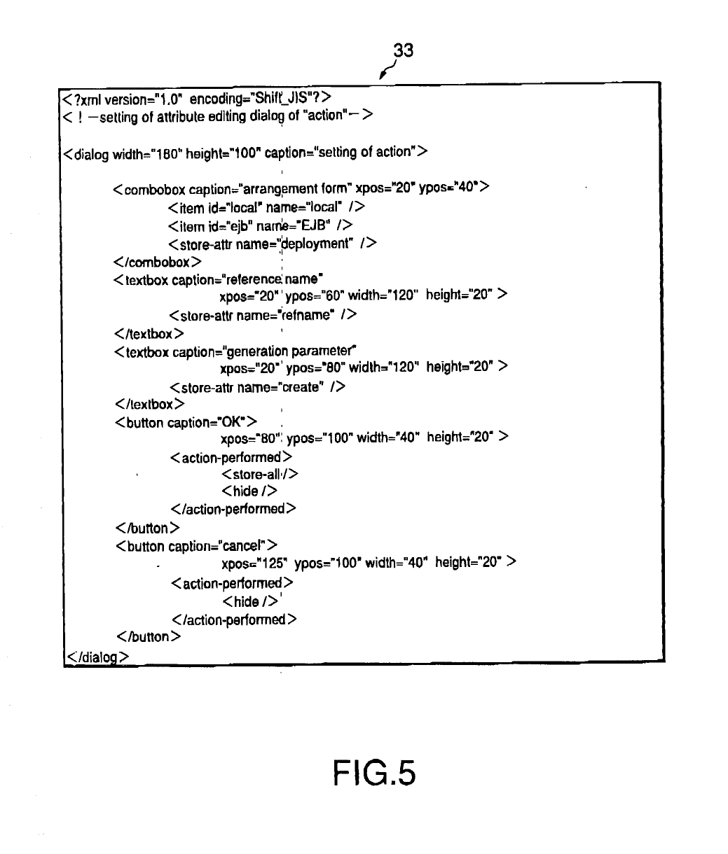

As shown in FIG. 1, the framework description file 30 includes the framework information definition file 31 for defining the overall structure of the framework. The framework information definition file 31 has a form as shown in FIG. 3, which shows a list of the software components arranged on the pallet 42 of the tool screen 41 as shown in FIG. 2. The framework information definition file 31 refers to the component basic information definition file 32 as shown in FIG. 4, in which the definition information (basic information such as attributes of software components and input-output relations) necessary to use each software component by the drawing tool part 10 is defined. Further, the component basic information definition file 32 refers to several files (the setting dialog definition file 33, the icon image definition file 34, and the execution code 35). Among them, one or more setting dialog definition files 33 are given to one software component so as to define a procedure of displaying a setting dialog used for setting the operation of the software component. Specifically, the setting dialog definition file 33 has a form as shown in FIG. 5; and the image of the setting dialog displayed on the tool screen is as shown in FIG. 6. It is noted that the framework information definition file 31, the component basic information definition file 32, and the setting dialog definition file 33 are described in a versatile language with a tag (specification description language) such as an XML language. The icon image definition file 34 is given in a form of one-to-one correspondence to each software component and defines an icon image displayed on the tool screen (see FIG. 7). The icon image definition file 34 is given as an image file in an optional form. The execution code 35 is a main part of a software component for executing a part of the processes of the software product; and it is required when the developed software product (application) is executed. A developer of the software components can distribute the definition files (the component basic information definition file 32, the setting dialog definition file 33, the icon image definition tile 34, and the execution code 35) all together as a software component.

The file input-output part 23 outputs information concerning the relationship of the software components corresponding to the connection relationship of the icons defined by the drawing tool part 10 as a user outputting file 36. Further, the user outputting file 36 is a final output article obtained as a result of a development of a software product; and it is outputted, for example, as a drawing file described in the XML language, which is independent of the structure of a development environment, an execution environment and an method for implementation. Such a drawing file is an executable program; and it can be executed when it is loaded in the execution environment.

Next, the operation of the software development support system 1 having such a configuration will be explained.

In the software development support system 1 shown in FIG. 1, when the tool body 11 of the drawing tool part 10 is started, the tool body 11 calls the external program execution part 12, thereby calling the customizing part 20 via the external program execution part 12.

At this time, the customizing part 20, as an initialization process, reads the framework information definition file 31 by the framework interpretation executing part 21 to set the overall operation of the user interface provided by the tool body 11 on the basis of the contents described in the framework information definition file 31. Specifically, in the framework information definition file 31, software components arranged as icons on the pallet 42 of the tool screen 41: are listed; thus, the customizing part 20 reads the component basic information definition file 32 corresponding to each of the listed software component, on the basis of the framework information definition file 31. In addition, the component basic information definition file 32 includes reference to the setting dialog definition file 33 and the icon image definition file 34; thus, the customizing part 20 reads these files so as to arrange the icons corresponding to all the software components on the pallet 42 of the tool screen 41, thereby entering an editing state.

In this editing state, when a user selects a command for operation setting (property setting) of the icons (software components) arranged in the edit area 43 of the tool screen 41, the command is transferred from the tool body 11 of the drawing tool part 10 to the framework interpretation executing part 21 of the customizing part 20 via the external program execution program 12. By doing this, under control of the framework interpretation executing part 21, the setting dialog, the displaying procedure of which is described in the setting dialog definition file 33, is popped up on the tool screen 41 by the interface operation control part 22; and the operation setting of the software components can be performed.

The results edited in the edit area 43 of the tool screen 41 are outputted in, the user outputting file 36 (a drawing file described in the XML language or others) by the file input-output part 23 under control of the framework interpretation executing part 21. The user outputting file 36 outputted in this way is an executable program; and it operates as an actual software product (application) when it is loaded in the execution environment and linked with the execution code 35.

As mentioned above, according to this embodiment, the definition information and the design information, which are set as information inherent to the software components and necessary for setting the user interface of the drawing tool part 10, are prepared as definition files (the framework information definition file 31, the component basic information definition file 32, the setting dialog definition file 33, and the icon image definition file 34), independently of the tool body 11 of the drawing tool part 10; and during operation of the drawing tool part 10, the system reads the definition files and operates. Therefore, unless the program of the drawing tool part 10 is changed and extended, new software components and frameworks (sets of software components) can be easily added.

Further, according to this embodiment, the framework information definition file 31, the component basic information definition file 32, and the setting dialog definition file 33, which are definition files, are described in the XML language that is a versatile specification description language independent of a specific language for implementation. Therefore, in the case that a function for interpreting the XML language is provided, even if a language for implementation or an internal structure of the drawing tool part 10 is changed, the existing software components can be reused as they are.

In the aforementioned embodiment, the XML language is used as a specification description language for describing the framework information definition file 31, the component basic information definition file 32, and the setting dialog definition file 33, which are definition files. However, the present invention is not limited to it; and the definition files 31, 32 and 33 can be described in an optional language such as an HTML language or riff.

Further, in the aforementioned embodiment, the case is explained as an example, in which the customizing part 20 is implemented in the drawing tool part 10 (a general-purpose drawing tool) as an add-on program. However, the present invention is not limited to it; and the drawing tool part 10 and the customizing part 20 may be implemented as an integrated program.

Furthermore, in the aforementioned embodiment, both of the drawing tool part 10 and the customizing part 20 can be realized as a program that operates on a computer system 80; as shown in FIG. 8. In addition, the software components can be also realized as a program that operates on the computer system 80. In this case, the computer system 80 has a bus 88, a processor 81, a memory 82, and a hard disk 83, and peripheral equipment (an input device 84 such as a keyboard and a mouse, an output device 85 such as a display and a printer, an FD drive 86, and a CD-ROM drive 87), which are connected to the bus 88. The aforementioned programs are stored in a recording medium capable of being read by a computer such as the memory 82, the hard disk 83, a flexible disk 89, and a CD-ROM 90; and they are successively read and executed by the processor 81, so that the aforementioned functions and procedures can be realized.

What is claimed is:

1. A general-purpose software development support system for supporting a development of a software product consisting of a plurality of software components, said system comprising:
a drawing tool part that provides a user with a user interface for defining a flow of processes among a plurality of software components by connecting icons of said software components by lines on a tool screen;
a definition file storing part that stores a definition file including definition information and design information with respect to each of said software components, said definition information and said design information specifying
a setting and an operation of said user interface provided by said drawing tool part; and
a customizing part that customizes said user interface provided by said drawing tool part, on the basis of said definition file stored in said definition file storing part.

2. The system according to claim 1, wherein said customizing part includes an interpretation executing part that interprets said definition file stored in said definition file storing part to set an operation of said user interface on the basis of said definition information and said design information of each of said software components included in said definition file.

3. The system according to claim 2, wherein said customizing part further includes an interface operation control part that controls an operation of said user interface on the basis of interpretation results obtained by said interpretation executing part.

4. The system according to claim 1, wherein said definition file is described in a versatile specification description language.

5. A general-purpose software development support method for supporting a development of a software product consisting of a plurality of software components, providing a user with a user interface for defining a flow of processes among said software components by connecting icons of said software components by lines on a tool screen, said method comprising the steps of:
preparing a definition file including definition information and design information with respect to each of said software components, said definition information and said design information specifying a setting and an operation of said user interface; and
setting an operation of said user interface on the basis of said definition information and said design information of each of said software components included in said definition file.

6. The method according to claim 5, further comprising the step of controlling an operation of said user interface, while interpreting said definition information and said design information of each of said software components included in said definition file.

7. The method according to claim 5, wherein said definition file is described in a versatile specification description language.

8. A general-purpose software development support program product for supporting a development of a software product consisting of a plurality of software components, providing a user with a user interface for defining a flow of processes among said software components by connecting icons of said software components by lines on a tool screen, said program product make a computer execute the procedures of:
preparing a :definition file including definition information and design information with respect to each of said software components, said definition information and said design information specifying a setting and an operation of said user interface; and
setting an operation of said user interface on the basis of said definition information and said design information of each of said software components included in said definition file.

9. The program product according to claim 8, further making a computer execute the procedure of controlling an operation of said user interface, while interpreting said definition information and said design information of each of said software components included in said definition file.

10. The program product according to claim 8, wherein said definition file is described in a versatile specification description language.

11. A software component adapted to be used with a general-purpose software support system that interprets a definition file to customize a user interface, said software component comprising:
an execution code for executing a process of said software component on a computer; and
a definition file accompanying said execution code, said definition file including definition information and design information inherent to said software component, said definition information and said design information specifying a setting and an operation of said user interface.

12. The software component according to claim 11, wherein said definition file is described in a versatile specification description language.
